(19) United States
(12) Patent Application Publication
(10) Pub. No.: US 2014/0130500 A9
(43) Pub. Date: May 15, 2014

(54) DESIGN AND MANUFACTURING OF AN ADVANCED LOW COST MICRO-TURBINE SYSTEM

(71) Applicant: Dynamo Micropower, Boston, MA (US)

(72) Inventors: Jason H. Ethier, Boston, MA (US); Ivan Wang, Boston, MA (US); Daniel Trostli, Brookline, MA (US)

(21) Appl. No.: 13/782,429

(22) Filed: Mar. 1, 2013

Related U.S. Application Data
(63) Continuation-in-part of application No. 13/399,047, filed on Feb. 17, 2012.
(60) Provisional application No. 61/605,377, filed on Mar. 1, 2012.
(60) Provisional application No. 61/444,138, filed on Feb. 18, 2011.

(51) Int. Cl. F02C 3/00

(52) U.S. Cl. CPC F02C 3/00
USPC 60/722

(57) ABSTRACT

A micro-turbine engine has been designed using vertically simple geometry, such that the engine components are designed with features that are defined geometrically, but not necessarily manufactured, by extruding two-dimensional features along a primary direction. This design approach reduces manufacturing and assembly costs. The present invention discloses designs to improve micro-turbine engine performance, and methods of manufacturing components that further reduce cost. The design improvements include methods of implementing a multi-stage micro-turbine engine using nested stages and nested flow paths, usage of multi-phase fuel injectors and supercritical fuel injectors to increase fuel flexibility and burner efficiency, and method of cooling a turbine rotor by building cooling blades on the opposite side of the rotor that act as a fluid pump to provide cooling by convection. The manufacturing methods include methods to build alignment features into components to improve ease of assembly, methods for manufacturing combustor components using sheet metal, and methods for manufacturing features that are not aligned with the primary direction of the vertically simple component.

### CROSS REFERENCE TO RELATED APPLICATION

This application claims priority to U.S. Provisional Patent Application No. 61/605,377, filed Mar. 1, 2012, titled “Features and controls for a novel architecture combined cycle micro-turbine.” This application is a continuation-in-part of U.S. patent application Ser. No. 13/399,047, filed Feb. 17, 2012, titled “Fluid Flow Devices with Vertically Simple Geometry and Methods of Making the Same,” which claims priority to U.S. Provisional Patent Application No. 61/444,138 filed Feb. 18, 2011, titled “Applications and manufacture of a novel architecture combined cycle micro-turbine.” The contents of each of these applications are incorporated herein by reference in their entireties.

### STATEMENT REGARDING FEDERALLY SPONSORED RESEARCH OR DEVELOPMENT

This invention was made with government support under Grant No. 1143081, awarded by the National Science Foundation. The government has certain rights in this invention.

### FIELD OF THE INVENTION

The present invention relates to the field of micro-turbines, including but not limited to turbomachinery, combustion systems, fuel injection systems, heat exchangers, and power electronics. Specifically, the present invention relates to design and manufacturing of micro-turbine systems.

### BACKGROUND OF THE INVENTION

Micro-turbines have intrinsically high power density, low maintenance, longer lifetime, fuel flexibility, potentially higher efficiency, and more compact form factor. These advantages make micro-turbines an excellent choice for remote power generation and distributed power generation.

A significant portion of recent research is focused on improving the overall efficiency of centimeter-scale micro-turbines in converting fuel to usable electric power. Most of these efforts have led to solutions such as ceramic turbine components, high efficiency regenerative heating components, air-powered bearings, and highly complicated component geometries. These solutions lead to high costs that make it too expensive for mass adoption of micro-turbine technology as a means of implementing distributed generation.

Another branch of micro-turbine research is focused on the design and manufacturing of millimeter-scale micro-turbines that are constructed out of either metal or silicon. The metal engines are manufactured using micro-machining techniques. The silicon engines are manufactured using semiconductor and micro-electro-mechanical system (MEMS) technologies. Reducing the characteristic length of the engine in this way theoretically increases the power density, but prohibitively expensive manufacturing technologies such as the ones described above are required.

In addition to using the micro-turbine as a stand-alone power generator, it is possible to implement the micro-turbine engine as a part of a combined heat and power system for single family homes. By doing so, each household can reduce carbon dioxide emissions by 1 ton per year. In addition, micro-turbine engines can use a wider variety of fuels—such as heating oil, ethanol, syngas, and natural gas—with negligible nitrogen and sulfur oxide emissions compared to those produced by fossil fuel power plants.

### SUMMARY OF THE INVENTION

Aspects of the invention relate to the recognition of several methods to improve the commercial viability of the low-cost micro-turbines even further. In some embodiments, commercial viability may be improved by increasing the pressure ratio of the micro-turbine, which increases the thermodynamic efficiency of the system. In some embodiments, commercial viability may be improved by improving the tolerance between components, in particular the tolerance within flow passages, which also increases system efficiency. In some embodiments, commercial viability may be improved by implementing assembly procedures that are more efficient and thereby further reducing manufacturing costs.

The present invention defines, in various embodiments, the design architecture and manufacturing methods for creating an advanced small-scale micro-turbine engine, which can in turn be used in a variety of applications, including but not limited to, a portable electric power generator and a combined-heat-and-power system. In one embodiment, the micro-turbine according to the present invention consists of a core micro-turbine engine, whose components are designed with primarily vertically simple geometry such that they can be manufactured using simple manufacturing processes, and can generate mechanical shaft power from burning fuel (e.g., hydrocarbon fuel) or simply expanding hot gas, as well as an electric motor that can be used as both a starter motor and an electric generator, and is mechanically linked to the micro-turbine engine, such that the overall system generates electric power from combusting fuel.

In some embodiments, a micro-turbine engine comprises components, each of which is a physical part of the micro-turbine engine that by design may not be separated into two or more separate physical parts. In some embodiments, a micro-turbine component comprises features, each of which has one or more distinguishing geometry compared to adjacent features, and may also have a distinct function compared to adjacent features. In one embodiment, a micro-turbine core rotor comprising the following features—a rotating disk with integral shaft, integral compressor blades, and/or integral turbine blades—is a component of the micro-turbine engine, and may not be further separated or disassembled into two or more physical parts. In another embodiment, a diffuser stator component comprising a base structural support, integral diffuser blades, and/or integral alignment features, is a component of the micro-turbine engine and may not be further separated into individual feature.

In some embodiments, the micro-turbine engine physically consists of or comprises stacked structural components and one or more rotor disks. In some embodiments, the geometry of the structural components and the rotor disks is designed to permit extruding two-dimensional features along a single primary direction. Thus, in some embodiments, the geometry of the structural components and the rotor disks is manufactured by extruding two-dimensional features along a single primary direction. In some embodiments, this type of geometry is described herein as “vertically simple”.

In some embodiments, a vertically simple micro-turbine engine component comprises geometric features that are curvilinear in only two directions that make up a plane, but not curvilinear in the third direction. In one embodiment, compressor blades on the core rotor are features that are curvilinear in the plane of the rotor disk. In other embodiments, a micro-turbine engine component comprises features that may be manufactured using a tool path that is curvilinear in the two working plane directions and not the third one. In one embodiment, a compressor blade on the core rotor may be manufactured using a toolpath, for example on a 2.5 axis CNC mill, that is curvilinear in the plane of the rotor face, but is not curvilinear in the direction that is normal to the rotor face. In another embodiment, a compressor inlet component comprises a filleted inlet surface whose geometry is curvilinear in all three direction, but may be manufactured, for example on a 2.5 axis CNC mill, using a ball endmill with the desired fillet radius and a toolpath that is only curvilinear in two directions.

The vertically simple design allows each physical component to be manufactured using conventional (e.g., 2.5-axis) CNC milling or similar methods using conventional machine tools that are effective at creating contoured shapes along the planar directions but typically not along the out-of-plane direction, which reduces manufacturing costs. It should be appreciated that in the context of the phrase, “vertically simple design,” the term “vertically” does not compel that the feature be machined or formed in the vertical direction. For example, in some embodiments, a vertically simple design refers to a design in which a component is machined while fixed to a substantially horizontally oriented X-Y table, with a cutting tool mounted in a substantially vertically disposed Z axis spindle.

In some embodiments, the present invention improves the design and manufacturing of a micro-turbine by a combination of design improvements and lower-cost fabrication methods, any or all of which may be implemented to improve the performance and reduce the manufacturing cost of the micro-turbine.

In some embodiments, multi-stage micro-turbines are provided in which each stage consists of or comprises a compressor and turbine. It should be appreciated that in some embodiments, the stages are independent and do not have to be aligned in any way relative to one another. However, in some embodiments, aligning the stages (e.g., collinearly aligning the rotational axes of the stages) facilitates modular design and assembly. In some embodiments, housings and structure are readily fitted around stages having aligned axes. In some embodiments, the center axes of the turbo-machinery stages are collinearly aligned. In some embodiments, the center axes of one or more turbo-machinery stages are offset from the center axes of one or more other turbo-machinery stages.

In some embodiments, a multi-stage micro-turbine comprises multiple turbo-machinery stages that are positioned on one or both sides of a combustor. In some embodiments, one or more new stages is placed further away from the combustor from any existing stages on the same side of the combustor. In some embodiments, the flow paths of the turbo-machinery stages are formed such that the pressure and temperature of the flow inside the flow passages gets successively higher with closer radial distance to the center axis of the micro-turbine. In some embodiments, this type of multi-stage micro-turbine is herein referred to as an “axially-nested” multi-stage micro-turbine.

In another embodiment of the invention, a multi-stage compressor or turbine is configured and arranged with more than one set of blades on a radial compressor or radial turbine rotor, with each set of blades at a different radial location. In some embodiments, the multi-stage compressor or turbine is configured and arranged with a matching number of sets of blades on a matching stator, downstream of the rotor blades for the compressor, and upstream of the rotor blades for the turbine, such that the flow goes through multiple rotor-stator stages before existing the compressor or turbine. This type of multi-stage compressor or turbine may be herein referred to as a “radially-nested” multi-stage compressor or turbine.

In another embodiment of the invention, each component of a multi-stage compressor or turbine has integral alignment features that are designed into the component itself, either as a non-interfering feature or a recess, such that the components rely on the alignment features to align themselves during assembly without the need for any external alignment.

In another embodiment of the invention, the integral alignment features that are located in the flow path have aerodynamically contoured geometry such that the presence of the alignment features do not affect the flow characteristics.

In another embodiment of the invention, each cylindrical liner of the micro-turbine combustor is manufactured by first cutting out patterns in a flat piece of sheet metal using a conventional process such as water-jet cutting, and then rolling the sheet metal into a cylinder, and finally welding the seam to form the cylindrical liner.

In another embodiment of the invention, one or more components of a micro-turbine engine have one or more features whose primary direction is not parallel to the primary stacking direction of the components. This type of feature may be herein referred to as an “angled feature”. The angled features may be fabricated by first rotating the working plane of the manufacturing machine, such as, for example, a CNC mill or water-jet cutter, and then manufacturing the feature. In such embodiments, the working surface itself may be rotated. However, in some embodiments, an angled support structure may be placed below the to-be-manufactured component, such that the primary direction of the angled feature is parallel to the direction of the manufacturing machine.

In another embodiment of the invention, a high temperature rotor with blades on only one side may be cooled by placing blades on the opposite side, such that the blades act as a compressor or a fluid pump when the rotor is rotating and the moving flow cools the rotor by convection.

In another embodiment of the invention, the micro-turbine uses one or more fuel injectors that inject multi-phase fuel into the micro-turbine such that the fuel can be combusted. One example of multi-phase fuel is a mix of liquid and vapor hydrocarbon fuel that is extracted from oil and gas well sites.

In another embodiment of the invention, the micro-turbine uses one or more supercritical fuel injectors that inject fuel at supercritical temperatures and pressures.

Aspects of the invention provide micro-turbine engines. In some embodiments, the engines comprise more than one radial compressor stage, each of which is paired with a radial outflow or inflow turbine stage, and at least one combustor stage, and each pair of compressor and turbine is oriented with its rotation axis parallel to the axis of the combustor, axially distributed on both sides of the combustor, and in fluid communication with each other in succession via nested flow passages. In some embodiments, the engines comprise at least one compressor stage, at least one turbine stage, and at least one combustor, each stage comprising components that are designed with vertically simple geometry such that each component comprises features defined geometrically, but not necessarily manufactured, by extruding two-dimensional features along a primary direction, and the alignment between any two adjacent components is enforced by one or more features that are integral to one of the components. In some embodiments, a vertically simple micro-turbine engine component comprises geometric features that are curvilinear in only two directions that make up a plane, but not curvilinear in the third direction. In other embodiments, a micro-turbine engine component comprises features that may be manufactured using a tool path that is curvilinear in the two working plane directions and not the third one. In some embodiments, the engines have at least one compressor, at least one turbine, at least one combustor, and a plurality of components defining a fluid flow path through at least one compressor, at least one turbine, and at least one combustor, wherein the geometry of each feature on a component defining the fluid flow path is curvilinear in only one plane of the component.

Further aspects of the invention provide multi-stage turbo-machine components. In some embodiments, the components comprise one rotor with two or more sets of blades, and each set of rotor blades is evenly distributed circumferentially at a different radial location, and one stator with matching sets of blades, and each set of stator blades is evenly distributed circumferentially and radially adjacent to its corresponding rotor blades, such that the combined rotor-stator system is a turbo-machine component with two or more stages.

Further aspects of the invention provide combustion chamber. In some embodiments, the combustion chamber comprises cylindrical liners, wherein each liner is manufactured by first making cut outs on a sheet of material, and then rolling the material into a cylinder and bonding the resulting seam, such that the end product is a cylindrical component in which the cut outs on the original sheet of material form the desired features on the cylindrical component.

According to further aspects of the invention, a micro-turbine engine is provide that comprise: (i) a plurality of stages, wherein each stage comprises a radial compressor connected through a rotational axis to a radial turbine, wherein the radial compressor has an impeller configured and arranged for rotating about the rotational axis, a first fluid inlet, a first fluid outlet and a fluid path connecting the first fluid inlet to the first fluid outlet through the impeller, and wherein the radial turbine has a turbine rotor configured and arranged for rotating about the rotational axis, a second fluid inlet, a second fluid outlet, a fluid path connecting the second fluid inlet to the second fluid outlet through the turbine rotor, and at least one nozzle configured and arranged for directing fluid from the second fluid inlet to impinge on one or more blades of the turbine rotor thereby rotating the turbine rotor, and (ii) a housing forming a combustion chamber, the combustion chamber having a third fluid inlet and a third fluid outlet. In some embodiments, the plurality of stages are configured and arranged such that the first fluid outlet of at least one radial compressor is in fluid communication with the first fluid inlet of at least one other radial compressor, and the first fluid outlet of at least one radial compressor is in fluid communication with the third fluid inlet of the combustion chamber. And, in some embodiments, the plurality of stages are configured and arranged such that the second fluid outlet of at least one radial turbine is in fluid communication with the second fluid inlet of at least one other radial turbine, and the second fluid outlet of at least one radial turbine is in fluid communication with the third fluid outlet of the combustion chamber.

### BRIEF DESCRIPTION OF THE DRAWINGS

A more complete appreciation of the invention and many attendant advantages thereof will be readily obtained as the same becomes better understood by reference to the following detailed description when considered in connection with the accompanying schematic drawings.

FIG. 1 shows a schematic of a non-limiting example of an axially-nested micro-turbine engine, in which the stages are located on both sides of the combustor.

FIG. 2 shows a side view and top view of a non-limiting example of a sector of an engine component with castle-like structure.

FIG. 3 shows an isometric view of a non-limiting example of a sector of an engine component with castle-like structure.

FIG. 4 shows another schematic of a non-limiting example of an axially-nested micro-turbine engine, in which the stages are located on the same side of the combustor.

FIG. 5 shows a side view and top view of a non-limiting example of a radially-nested compressor rotor.

FIG. 6 shows a side view and top view of a non-limiting example of a radially-nested compressor stator.

FIG. 7 shows a side view and top view of a non-limiting example of a radially-nested compressor assembly, comprising the radially-nested compressor rotor and stator. The dashed lines show the general orientation of the rotor and stator blades.

FIG. 8 shows a side view and top view of a non-limiting example of a 60-degree sector of a radially-nested compressor assembly. In particular, the flow passage is shown in the side view.

FIG. 9 shows a side view and top view of a non-limiting example of a 60-degree sector of the radially-nested turbine assembly. In particular, the flow passage is shown in the side view.

FIG. 10 shows a cross section of an exploded view of a non-limiting example of a core gas turbine assembly.

FIG. 11 shows a cross section of a non-limiting example of a core gas turbine assembly.

FIG. 12 shows the detailed views of alignment features in a non-limiting example of a core gas turbine assembly cross section.

FIG. 13 shows an angled view from above and a top view of a non-limiting example of a diffuser stator plate with alignment features for an example micro-turbine engine.

FIG. 14 shows a detailed view of the alignment feature from a non-limiting example of a diffuser stator plate.

FIG. 15 shows an angled view from above and a top view of a non-limiting example of a nozzle guide vane plate with alignment features for an example micro-turbine engine.

FIG. 16 shows a detailed view of non-limiting example of an alignment feature from a nozzle guide vane plate.

FIG. 17 shows a non-limiting example of a sheet metal part with cut-outs, and the cylindrical combustor liner that is created by rolling the sheet metal part into a cylinder.

FIG. 18 shows an angled view of a non-limiting example of a sheet metal part with cut-outs, and an angled view of the rolled-up sheet metal part that also shows the seam as a result of rolling the sheet metal. The seam is welded to form a complete cylindrical liner for the combustor.

FIG. 19 shows a cross section view and a side view of a non-limiting example of a component that has angled features.

FIG. 20 shows cross section views of a non-limiting example of a component with angled features, but rotated in two different orientations such that one of the angled features is in the vertical direction.

FIG. 21 shows an assembly of a non-limiting example of a component with angled features and a support structure with an angled contact surface.

FIG. 22 shows a cross section view of an assembly of a non-limiting example of a component with angled features and a support structure. The cross section view shows that the support structure maintains the component at an orientation such that one of the angled features is in the vertical direction.

FIG. 23 shows an angled view from above of a non-limiting example of a turbine rotor with cooling blades. The view from above shows the plurality of turbine blades.

FIG. 24 shows an angled view from below of a non-limiting example of a turbine rotor with cooling blades. The view from below shows the plurality of cooling blades.

FIG. 25 shows a cross section of a non-limiting example turbine assembly that contains a turbine rotor with cooling blades.

FIG. 26 shows a cross section of a non-limiting example of a micro-turbine engine that uses multi-phase fuel injectors to inject fuel that is a direct byproduct of oil and gas wells.

### DETAILED DESCRIPTION OF THE CERTAIN EMBODIMENTS

The present invention relates to design features and manufacturing methods for a micro-turbine engine, as will be apparent to one of ordinary skill in the art from the description set forth herein.

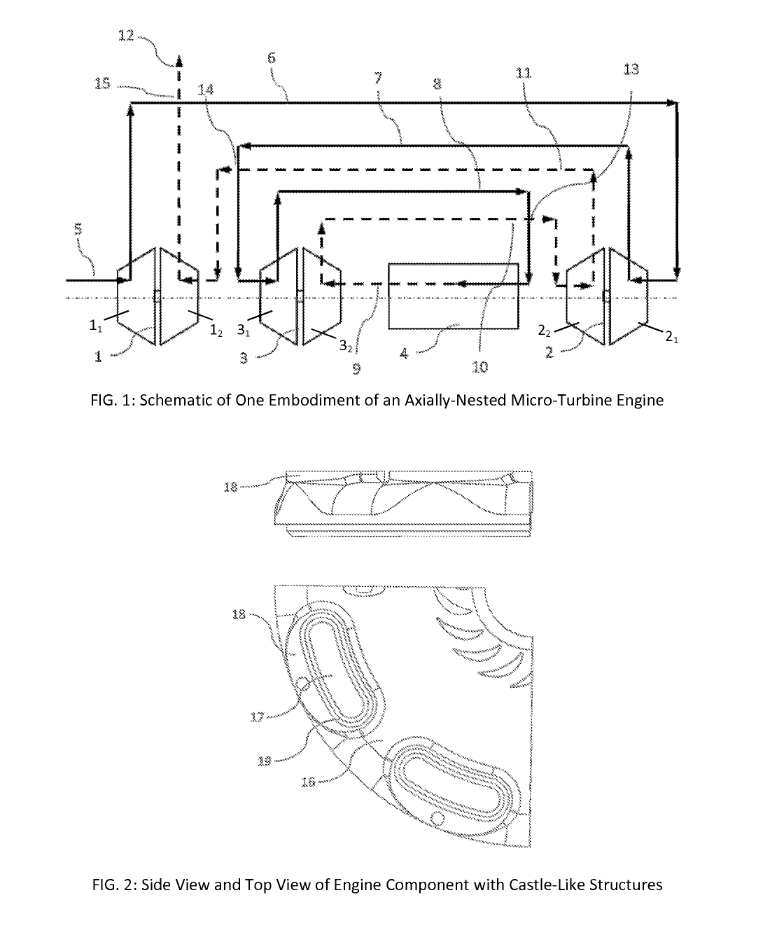

In some embodiments, one implementation of a multi-stage micro-turbine engine is an axially-nested micro-turbine engine. Each stage may consist of or comprise a single-stage compressor and turbine. FIG. 1 shows a schematic of a non-limiting example of a axially-nested multi-stage micro-turbine engine. The compressor flow paths are shown with solid lines, and the turbine flow paths are shown in dashed lines. The arrows indicate direction of flow. Each stage, 1, 2, and 3, is located such that the center axes are collinear, and may or may not also be collinear with the center axis of the combustion chamber 4. The inlet flow path 5 enters eithers a low pressure compressor 1₁ in one stage 1, and the flow path exit is routed through conduit 6 to the compressor 2₁ of the next stage 2. The next flow path exit is routed through conduit 7 to the compressor 3₁ of the next stage 3. The next exit is routed through conduit 8 to the combustion chamber 4. The combustion chamber flow path exit is routed through conduit 9 to the inlet of the turbine 3₁ of the highest pressure stage 3. The flow path exit of the highest pressure stage 3 turbine 3₂ is routed through conduit 10 to the next highest pressure stage 2 turbine 2₂. The next flow path exit is routed through conduit 11 to the next highest pressure stage 1 turbine 1₂. The exhaust 12 from the last turbine exits the engine.

In some embodiments, in the nested flow path structure, compressor and turbine flow paths alternate in low temperature and high temperature, and generally decrease in pressure as the radial position changes from inner-most to outer-most. The highest pressure compressor flow path 8 provides some thermal insulation for the highest pressure turbine flow path 10, and also acts as a recuperator by absorbing heat lost from the turbine flow.

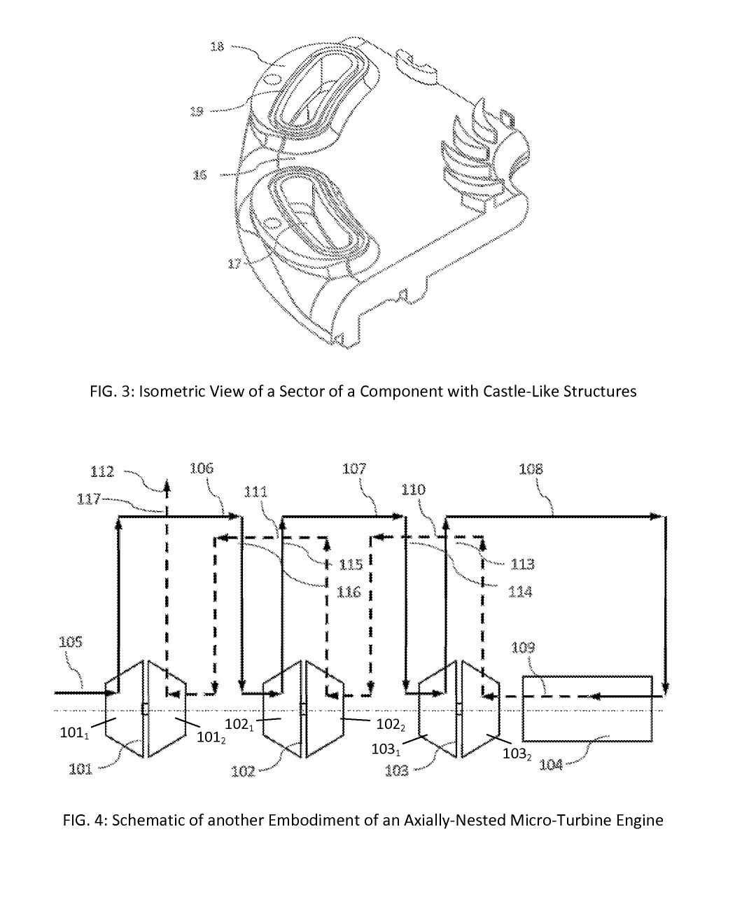

In some embodiments, the flow paths may cross at up to three locations 13, 14, and 15, as shown in FIG. 1. The flow path crossings may be physically implemented using a castle-like structure that separates the two flow paths. FIG. 2 shows a side view and a top view of an embodiment of a castle-like structure, with one flow path 16 that is oriented in the radial direction and one flow path 17 that is oriented in the axial direction. The castle-like structure 18 provides a physical barrier between the two flows. In the embodiment shown, O-rings 19 are used to seal the interface between the castle-like structure and the contact surface that is above the castle-like structure, such that there is no leakage between the two flow paths. Other sealing mechanisms, such as gaskets, may also be used for the same purpose. FIG. 3 shows an isometric view of a component with castle-like structure, and more prominently shows the different flow path directions. The radial flow path 16 and the axial flow path 17 are physically separated by the castle-like structures.

In some embodiments, another implementation of an axially-nested multi-stage micro-turbine engine is a configuration in which the stages are on the same side of the combustor, and axially located such that the higher pressure stage is closer to the combustor. FIG. 4 shows a schematic of an embodiment of an axially-nested multi-stage micro-turbine engine with stages on the same side of the combustor. The embodiment shown in FIG. 4 has three stages, 101, 102, and 103, in order of increasing pressure, and a combustor 104. The working fluid enters the micro-turbine engine at the inlet 105. The compressor flow paths 106, 107, and 108 connect the compressors 101₁, 102₁, and 103₁ in order of increasing pressure, with the highest pressure flow path 108 connecting the highest pressure compressor to the combustor. The turbine flow paths 109, 110, and 111 connect the turbines 101₂, 102₂, and 103₂ in order of decreasing pressure. The exhaust 112 from the last turbine exits the engine. The flow paths cross at five locations 113, 114, 115, 116, and 117 for the embodiment shown in FIG. 4. The flow path crossings may be physically implemented using a castle-like structure that separates the two flow paths.

Another embodiment of an axially-nested multi-stage micro-turbine engine is a configuration in which the compressor and turbine stages are not paired by pressure. The lowest pressure compressor is not necessarily mechanically connected to the lowest pressure turbine, and the highest pressure compressor is not necessarily mechanically connected to the highest pressure turbine.

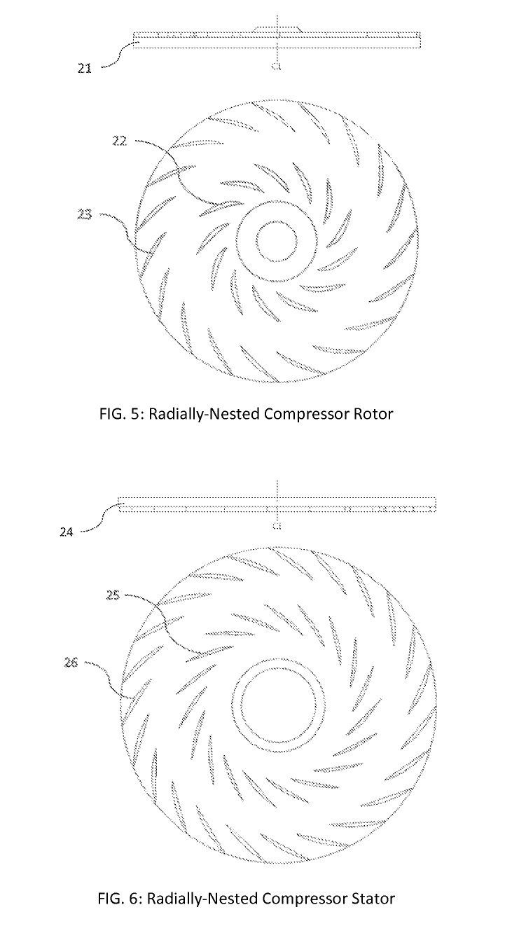

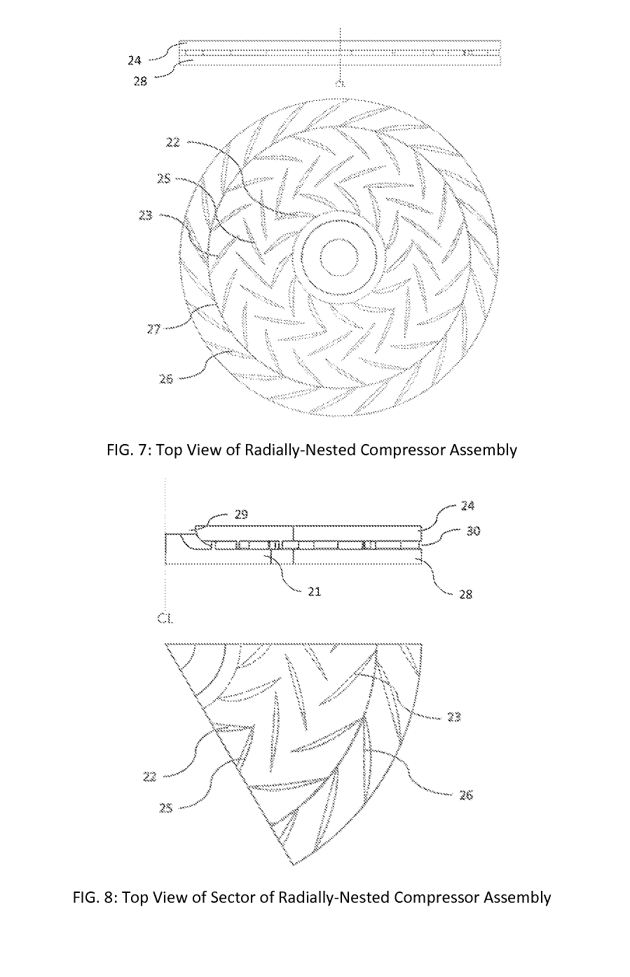

In some embodiments, another implementation of a multi-stage compressor or turbine is a radially-nested compressor or turbine. A rotor or stator component may achieve radial nesting of stages by having more than one set of blades, each set located at a different radial location, on a single rotor or stator. FIG. 5 shows one embodiment of a radially-nested compressor rotor 21, with one row of impeller blades 22 distributed along one radial location, and a second row of impeller blades 23 distributed along a different radial location. FIG. 6 shows one embodiment of a radially-nested compressor stator 24, with one row of diffuser blades 25 distributed along one radial location, and a second row of diffuser blades 25 distributed along a different radial location. Thus, two or more components may stack together to form a completed compressor assembly, as shown in FIG. 7. An additional stator layer 28 may surround the compressor rotor to form a stationary wall opposite the outer portion of the compressor stator. FIG. 7 also shows the general orientation of impeller and diffuser blades. There may also be a gap 27 between the compressor rotor 21 and additional stator 28 to allow the rotor to rotate without touching the stator. FIG. 8 shows a side view and a top view of a sector of the radially-nested compressor assembly. The top view shows the inlet 29 and the exit 30 of the multi-stage compressor.

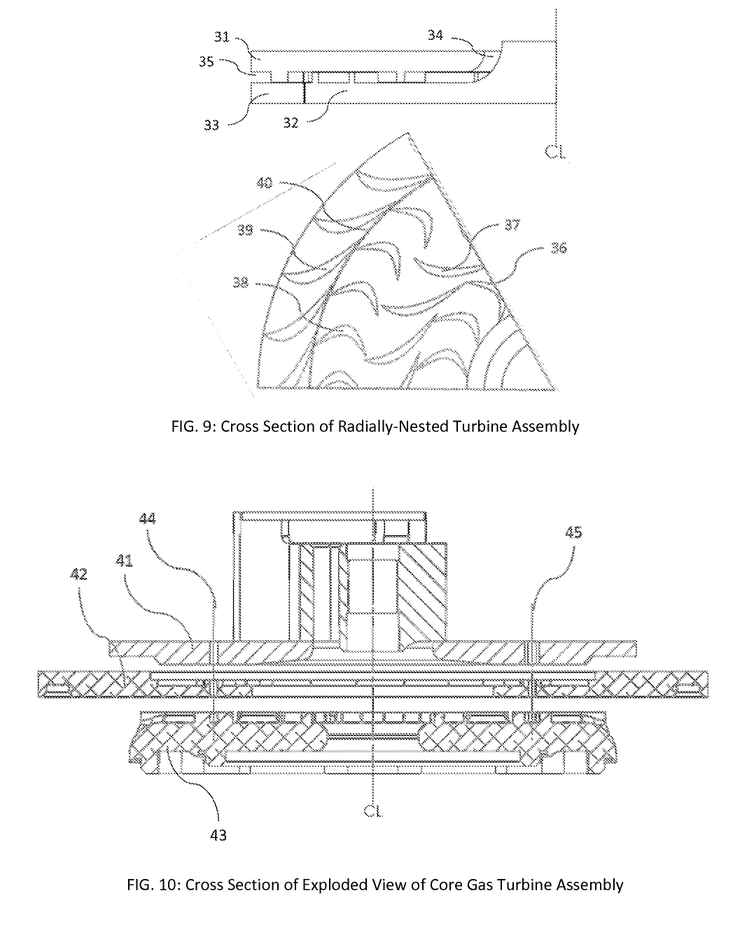

In some embodiments, a multi-stage turbine may be implemented using a similar radially-nested geometry. FIG. 9 shows one embodiment of a radially-nested turbine assembly. The side view shows the turbine stator 31 containing the nozzle guide vanes, and the turbine rotor 32 below the turbine stator. The turbine rotor may be surrounded by an additional stator layer 33, which may include a gap 40 in between. In the turbine stator, one set of nozzle guide vanes 39 may be located at a larger radius than the second set of nozzle guide vanes 37. In the turbine rotor, one set of turbine blades 38 is located at a larger radius than the second set of turbine blades 36. This embodiment is a radial inflow turbine, with inlet 35 at the outer radius and exit 34 at the inner radius. Another embodiment of a radially-nested turbine may be a radial outflow turbine.

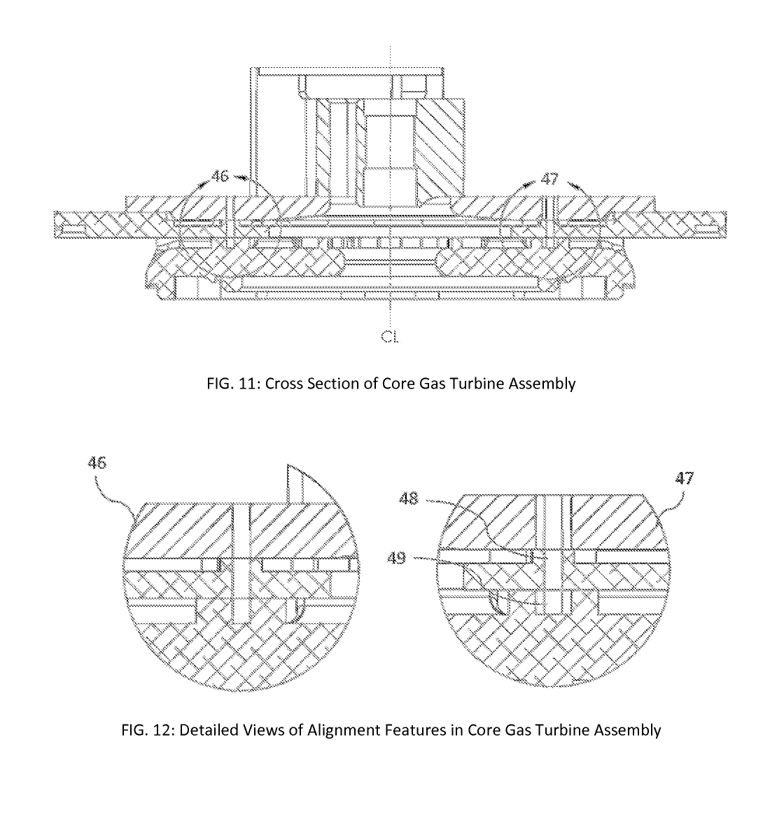

In some embodiments, the assembly of the micro-turbine system may be simplified by designing alignment and locating features as integral parts of the micro-turbine components. FIG. 10 shows a cross section of an exploded view of one embodiment of integrated alignment features in an example core gas turbine assembly of three components. In some embodiments, the core gas turbine assembly comprises the inlet and shroud 41, the diffuser stator layer 42, and the turbine stator layer 43. The rotor in the center is not shown. In some embodiments, the system may be assembled by stacking the components one on top of another in the order shown. In this embodiment, the alignment features 44 and 45 are holes that can be aligned by inserting alignment pins. FIG. 11 shows the embodiment in FIG. 10 in the assembled state instead of the exploded view. FIG. 12 shows the alignment features in more detailed views 46 and 47. The diffuser stator alignment feature 48 and the core turbine stator alignment feature 49 are designed to be integral to the respective components.

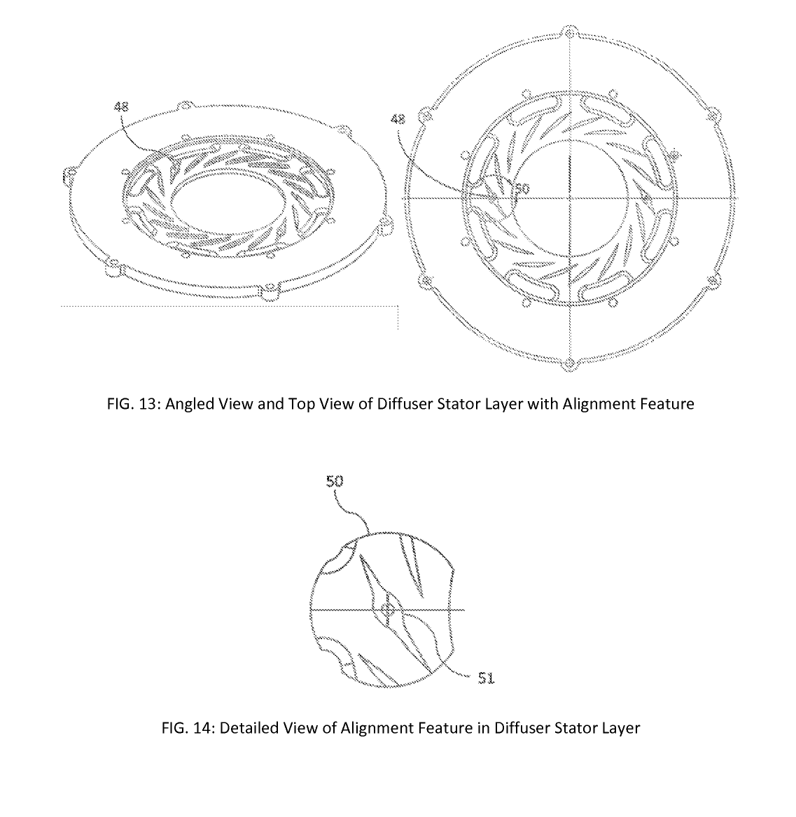

FIG. 13 shows an angled view from above and a top view of a diffuser stator layer with alignment features 48. FIG. 14 shows a detailed view 50 of a diffuser stator layer alignment feature. In some embodiments, the feature has a contoured shape 51 because it is a part of the flow path. A contoured shape is one embodiment of an integral alignment feature that reduces its impact on the neighboring flow characteristics.

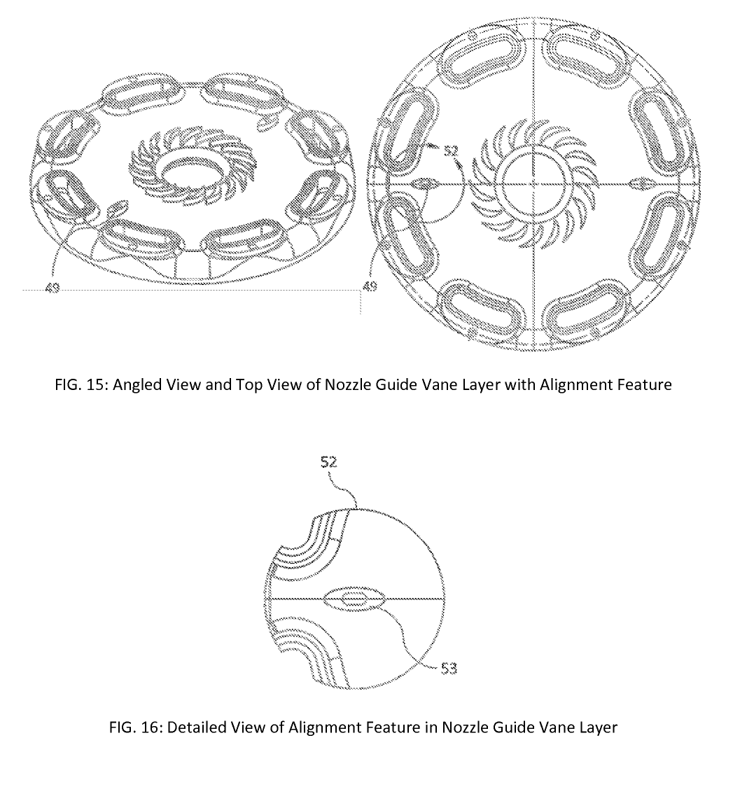

FIG. 15 shows an angled view from above and a top view of a diffuser stator layer with alignment features 49. FIG. 16 shows a detailed view 52 of a diffuser stator layer alignment feature. In some embodiments, the feature has a contoured shape 53 because it is a part of the flow path. A contoured shape is one embodiment of an integral alignment feature that reduces its impact on the neighboring flow characteristics.

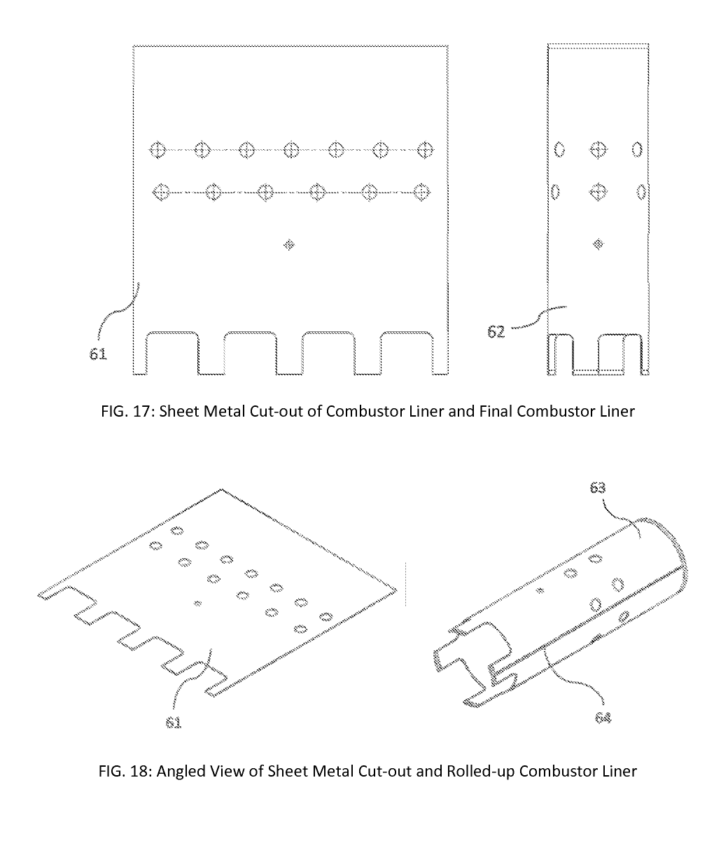

In some embodiments, methods of manufacturing a combustion system, comprising cylindrical components, involve cutting out desired patterns on a sheet of flat malleable material, and then rolling the sheet into a cylinder to arrive at the desired geometry. In one embodiment, the combustor comprises cylindrical liners made of sheet metal. FIG. 17 shows one example of a sheet metal part 61 with cut-outs that are designed to give the desired liner shape after rolling up the sheet metal, and the final combustor liner 62 after rolling the sheet metal into a cylinder and welding the seam. FIG. 18 shows an angled view of a sheet metal part 61, and the sheet metal then rolled-up into a cylinder. The rolled-up part contains a seam 64 as a resulting of it being formed from rolling sheet metal into a cylinder. The seam 64 may be welded or bonded via another method to form the final combustor liner.

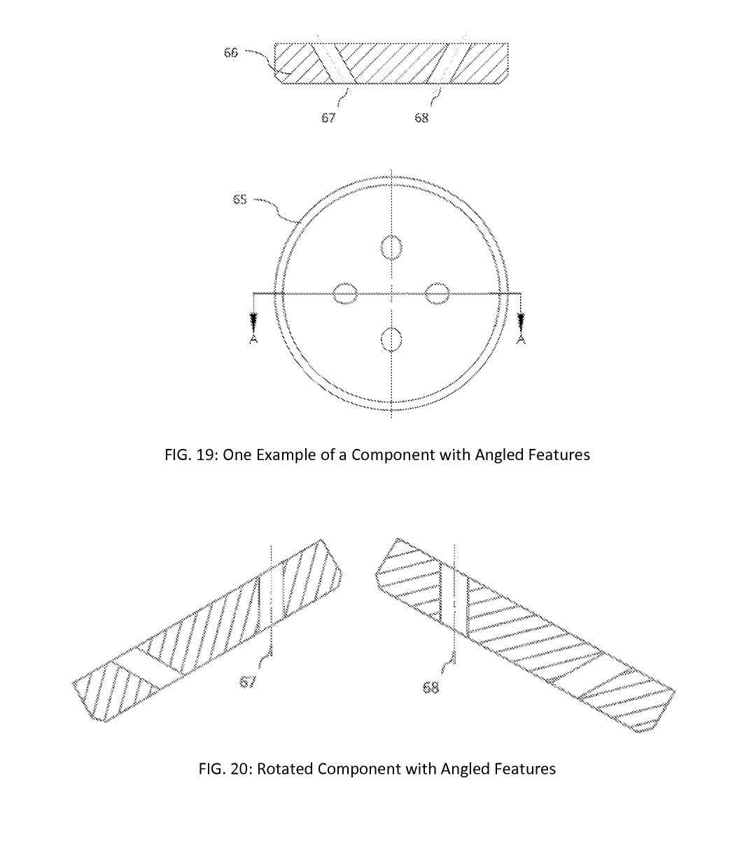

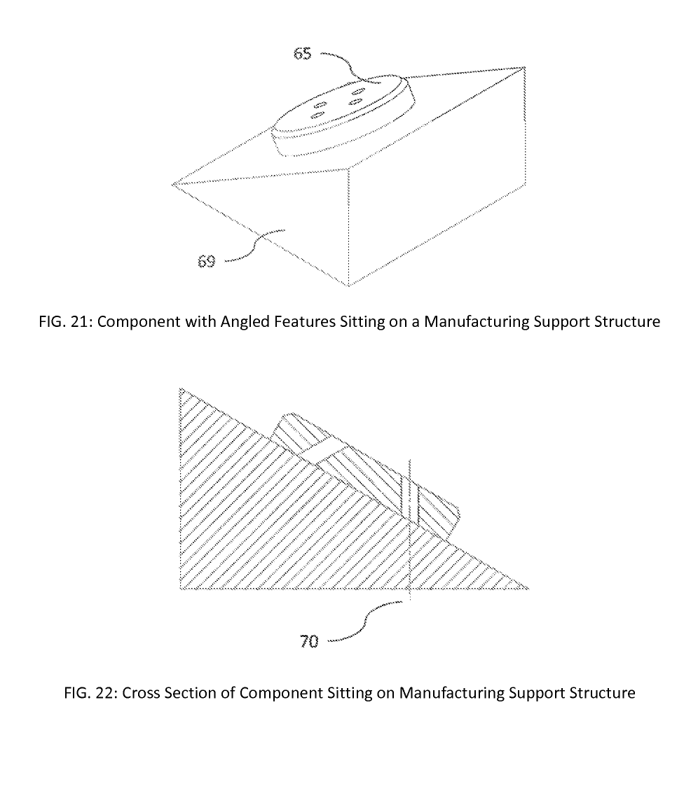

In some embodiments, a component with vertically simple geometry has geometry with primary direction that is perpendicular to the plane of the component. In one embodiment of the present invention, a component may have one or more angled features, which have a primary direction that is at an angle to the plane of the component but is not perpendicular to the plane of the component. FIG. 19 shows a cross section view 66 and a top view 65 of a component with angled features 67 and 68. In some embodiments, methods of manufacturing an angled feature involve rotating the component such that the primary direction of the angled feature is parallel to the tool direction of the manufacturing equipment, for example, the z axis of a mill. Examples of two possible orientations are shown in FIG. 20. In some embodiments, methods to achieve a different orientation involve placing a support structure with an angled contact surface below the component. FIG. 21 shows a component 65 with an angle feature, and a support structure 69 that is placed under the component to rotate the component by the desired angle. FIG. 22 shows a cross section view of an assembly of a component with angled features and a support structure. In this embodiment, one of the angled features 70 is consequently aligned with the vertical axis.

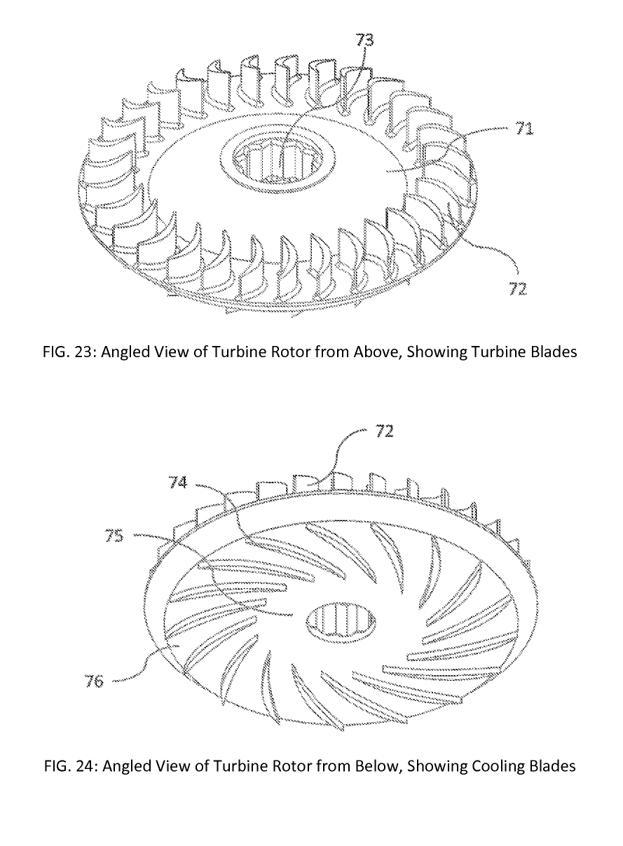

In some embodiments, a turbine rotor may be in contact with high temperature fluid. In one embodiment of the present invention, the rotor may be designed with cooling blades on the opposite side of the rotor from the turbine blades, such that when the rotor rotates the cooling blades pump air across the surface of the rotor and provide cooling by convection. FIG. 23 shows an angled view of a turbine rotor 71 from above, showing turbine blade 72. The FIG. does not show the shaft, which in this embodiment may be a separate component that is pressed into the spline 73 on the rotor. FIG. 24 shows an angled view of the same turbine rotor from below, showing the cooling blades 74. In the embodiment shown, the cooling blades are designed to be similar to compressor blades. The cooling blades draw in fluid near the inner diameter 75, and pumps fluid toward the outer diameter 76.

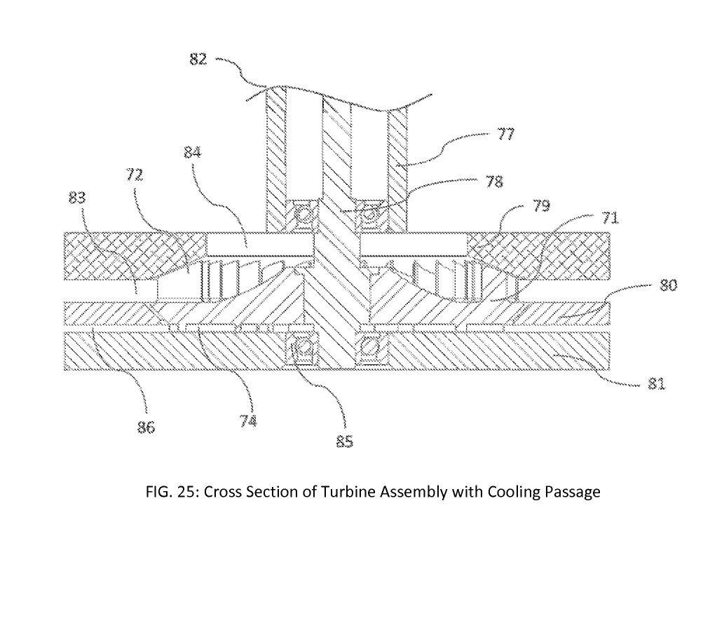

FIG. 25 shows a cross section of one embodiment of a turbine assembly with cooling blades on the turbine rotor and cooling passage in the assembly. The turbine assembly comprises a bearing support 77, shaft 78, shroud 79, rotor 71, rotor-level stator 80, and second bearing support 81 that also acts as the shroud for the cooling blades. The details of the bearing support are not shown, as indicated by the cut-off line 82. The embodiment shown in FIG. 25 is a radial inflow turbine. In this embodiment, the turbine accepts fluid at the inlet 83 at the outer radius, and exhausts fluid at the exit 84 at the inner radius. Another embodiment may be a radial outflow turbine. Also, in this embodiment, as the rotor spins, the cooling blades 74 draws in lower temperature fluid through the cooling fluid inlet 85, which may be the spacing between the bearing balls, as shown in FIG. 25, or a dedicated space. The cooling flow exits 86 at a larger radius. In some embodiments, flow induced by the cooling blades draws heat away from the turbine rotor by convection.

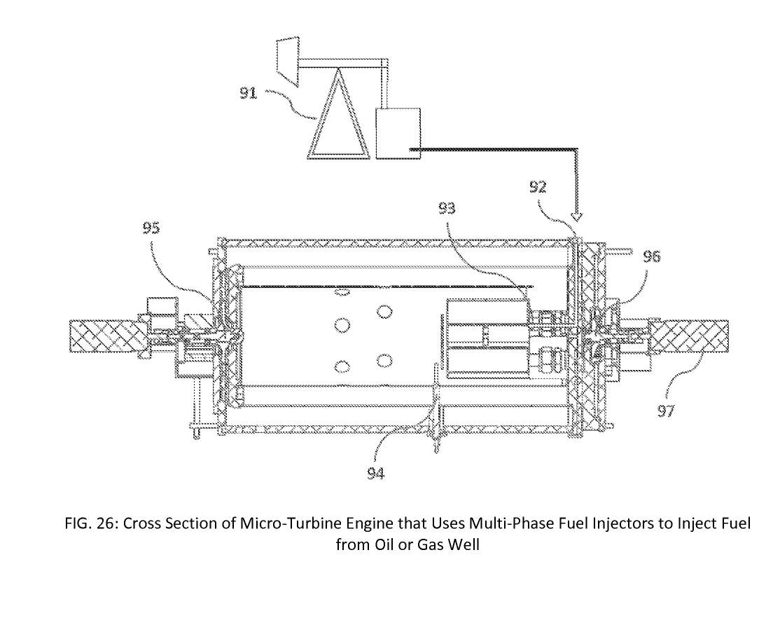

In one embodiment of the present invention, a micro-turbine system may use fuel that is an onsite byproduct of oil and gas wells, herein referred to as “onsite fuel”, when using a multi-phase fuel injector. FIG. 26 shows a cross section of a micro-turbine system whose fuel inlet is connected to an oil or gas field 91, representatively drawn as a pump jack. The onsite fuel may contain both vapor and liquid. In some embodiments, the fuel enters the engine at the fuel inlet port 92, and travels through the fuel injector 93, is ignited by the igniter 94, and is used to power the core gas turbine 95. The flow then enters a power turbine system 96, which produces electricity using an electric generator 97.

In one embodiment of the present invention, a micro-turbine system may use supercritical fuel injectors, for gaseous or liquid fuel, to improve engine efficiency.

In some embodiments of a multi-stage micro-turbine system, more than one compressor is used to increase the maximum pressure of the working fluid within the micro-turbine above the level that is achievable with a single-stage micro-turbine system. In some embodiments, each compressor rotates to impact energy into the working fluid with the end goal of increasing the pressure of the working fluid from inlet to outlet. In some embodiments, each turbine rotates to extract energy from high pressure and temperature working fluid. In some embodiments, there are two purposes for the turbine: one is to provide shaft power to the compressor such that the compressor can achieve adequate speed and pressure ratio, and the other is to provide additional shaft power that can be used for powering an external equipment.

In some embodiments of the multi-stage micro-turbine system, each stage comprises a pair of compressor and turbine. In some embodiments, the two are mechanically connected such that they rotate at the same angular velocity, but each stage in general rotates independently of other stages unless two or more stages are mechanically connected by a shaft or some other method. In some embodiments, the connection between a rotor and a stator can be accomplished in several different ways, including but not limited to a direct shaft connection or a monolithic construction. In certain embodiments, in a monolithic configuration, a single rotor has compressor blades on one side of the rotor face and turbine blades on the other side, and the rotor is a single piece of material. In some embodiments, methods of manufacturing a monolithic rotor that combines the compressor and turbine include casting and forging, or CNC machining from a single piece of raw material.

In some embodiments, each stage may have an additional output shaft, onto which a different system may be connected such that the stage provides shaft power for that system. In one embodiment of a multi-stage micro-turbine engine with an output shaft, the output shaft is attached to the stage that is located closest to the outer perimeter of the micro-turbine system. In some embodiments, he compressors are designed such that the desired pressure ratio is achieved. In some embodiments, the turbines attached to the stages that do not have an output shaft are designed to extract just enough power out of the flow to power the compressors. In some embodiments, the turbine that is attached to the stage that has a power output shaft is designed to extract power out of the flow to power its compressor, but also additional power that can be supplied to the power output shaft.

In some embodiments, the power output shaft may be connected to a plethora of systems and/or devices. In one embodiment of a multi-stage micro-turbine generator, the power output shaft from the micro-turbine engine is connected to an electric generator to produce electricity. In one embodiment, the power output shaft from the micro-turbine engine is connected to a gear system that can rotate and provide torque to a mechanical device. In one embodiment, the micro-turbine engine may also be directly connected to a mechanical device without intermediate gears, but the possible applied torque will be lower.

In some embodiments, the micro-turbine of the present invention may produce 5 kW to 30 kW of electricity from burning combustible fuels, such as hydrocarbons. In one embodiment of a micro-turbine power generator system, the micro-turbine of the present invention may be electrically linked to a machine or equipment at an oil well or a gas well such that the micro-turbine can be used to supply electricity to the equipment. In some embodiments, the micro-turbine combustor may be designed to burn flare gas from the oil and gas wells, such that the flare gas may be used as fuel for powering equipment onsite. In some embodiments, a large micro-turbine with similar internal geometry may also be designed to produce greater electric power.

The table below provides a non-limiting example of nominal performance parameters for a single stage engine, with and without a recuperator.

| | Lower | Nominal | Upper |
|---|---|---|---|
| Parameter | Bound | Value | Bound |
| Rotor diameter | 5 cm | 10 cm | 20 cm |
| Rotor RPM | 20000 RPM | 60000 RPM | 100000 RPM |
| Power output | 0.5 kW | 5 kW | 20 kW |
| Air mass flow | 10 g/s | 100 g/s | 500 g/s |
| Thermal efficiency | | | |
| Standard cycle | 5% | 8% | 10% |
| Recuperated | 10% | 15% | 20% |
| Fuel mass flow | | | |
| Standard cycle | 0.3 g/s | 2.8 g/s | 10.0 g/s |
| Recuperated | 0.2 g/s | 1.4 g/s | 5.0 g/s |

The table below provides a non-limiting example of approximate nominal performance parameters for two multi-stage engines compared to a single-stage engine, with and without a recuperator. In this example, several system parameters were kept the same as the 1-stage micro-turbine to better show the performance differences, but the actual multi-stage engines are not limited to the dimensions and operating conditions below.

| Parameter | 1-Stage | 2-Stage | 3-Stage |
|---|---|---|---|
| Rotor diameter | 10 cm | 10 cm | 10 cm |
| Rotor RPM | 60000 RPM | 60000 RPM | 60000 RPM |
| Compressor inlet | | | |
| Pressure | 1 atm | 1 atm | 1 atm |
| Temperature | 300K | 300K | 300K |
| Turbine inlet | 1200K | 1200K | 1200K |
| temperature | | | |
| Air mass flow | 100 g/s | 150 g/s | 200 g/s |
| Power output | 5 kW | 15 kW | 30 kW |
| Pressure ratio | | | |
| Stage 1 | 2.01 | 2.01 | 2.01 |
| Stage 2 | N/A | 1.76 | 1.76 |
| Stage 3 | N/A | N/A | 1.61 |
| Total | 2.0 | 3.5 | 5.7 |
| Thermal efficiency | | | |
| Standard cycle | 6.9% | 11.2% | 13.4% |
| Recuperated | 11.2% | 20.0% | 23.8% |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

This specification refers to certain patent references and technical references throughout the description, the disclosures of which are incorporated herein by reference in their entireties.

1-24. (canceled)

25. A micro-turbine engine, comprising:
(i) a plurality of stages, wherein each stage comprises a radial compressor connected through a rotational axis to a radial turbine,
wherein the radial compressor has an impeller configured and arranged for rotating about the rotational axis, a first fluid inlet, a first fluid outlet and a fluid path connecting the first fluid inlet to the first fluid outlet through the impeller, and
wherein the radial turbine has a turbine rotor configured and arranged for rotating about the rotational axis, a second fluid inlet, a second fluid outlet, a fluid path connecting the second fluid inlet to the second fluid outlet through the turbine rotor, and at least one nozzle configured and arranged for directing fluid from the second fluid inlet to impinge on one or more blades of the turbine rotor thereby rotating the turbine rotor, and
(ii) a housing forming a combustion chamber, the combustion chamber having a third fluid inlet and a third fluid outlet,
wherein the plurality of stages are configured and arranged such that:
(a) the first fluid outlet of at least one radial compressor is in fluid communication with the first fluid inlet of at least one other radial compressor, and the first fluid outlet of at least one radial compressor is in fluid communication with the third fluid inlet of the combustion chamber, and
(b) the second fluid outlet of at least one radial turbine is in fluid communication with the second fluid inlet of at least one other radial turbine, and the second fluid inlet of at least one radial turbine is in fluid communication with the third fluid outlet of the combustion chamber.

26-29. (canceled)

30. The micro-turbine engine of claim 25, wherein the geometry of one or more features of one or more components defining the fluid flow path through the radial compressor or radial turbine is curvilinear in only one plane of the component.

31. The micro-turbine engine of claim 25, further comprising:
a diffuser configured and arranged for directing fluid from the first fluid outlet to the second fluid inlet while increasing pressure of a fluid; or
one or more fuel injectors, each of which connects one or more sources of combustible fuel to the combustion chamber, such that the fuel is delivered to the combustion chamber and burned to heat up the micro-turbine flow.

32. The micro-turbine engine of claim 25, further comprising one or more alignment features that are integral to one or more of components of the micro-turbine engine and enforce alignment between any pair of components.

33. The micro-turbine engine of claim 25, wherein the rotational axis of each stage is collinearly aligned

34. The micro-turbine engine of claim 25, wherein each pair of compressor and turbine is oriented with its rotation axis parallel to the axis of the combustor, axially distributed on both sides of the combustor, and in fluid communication with each other in succession via nested flow passages.

35. The micro-turbine engine of claim 25, wherein each pair of compressor and turbine is oriented with its rotation axis parallel to the axis of the combustor, axially distributed on one side of the combustor, and in fluid communication with each other in succession via nested flow passages.

36. The micro-turbine engine of claim 25, wherein the compressor or turbine comprises one rotor with two or more sets of blades, and each set of rotor blades is distributed circumferentially at a different radial location, and one stator with matching sets of blades, and each set of stator blades is distributed circumferentially at a location that is radially adjacent to its corresponding rotor blades, such that the combined rotor-stator system is a compressor or turbine with two or more stages.

37. The micro-turbine engine of claim 25, whose flow path is routed through one or more additional radial inflow or outflow power turbine stages that rotate independently of other compressors or turbines, and are mechanically connected to one or more electrical generators, such that the rotation of the power turbines produces electricity.

38. The micro-turbine engine of claim 37, wherein the micro-turbine engine is configured such that during startup the electric generator is operated as an electric motor to spin the turbine, such that the turbine draws air through the engine from the engine inlet through the engine exit in order to start the engine.

39. The micro-turbine engine of claim 25, further comprising one or more alignment features that are integral to the engine components and that are aerodynamically shaped to reduce the flow disturbance.

40. The micro-turbine engine of claim 39, wherein aerodynamic shapes for alignment features are airfoil shapes or oval shapes with airfoil camber or oval major axis, respectively, aligned with the flow direction to minimize flow obstruction.

41. The micro-turbine engine of claim 25, wherein the fuel injectors are configured to inject multi-phase fuel containing liquid and/or vapor phases.

42. The micro-turbine engine of claim 25, wherein the fuel injectors are configured to inject liquid and/or vapor fuel at supercritical temperature and pressure.

43. The micro-turbine engine of claim 25, wherein the compressed flow is first routed to a heat exchanger that is also in contact with a waste heat source before entering the combustor, such that part or all of the heat that would be supplied to the compressed flow by burning fuel in the combustor is supplied through the heat exchanger with waste heat, and the fuel usage in the combustor is reduced or eliminated.

44. The micro-turbine engine of claim 25, wherein the combustion chamber comprises cylindrical liners that are each manufactured by a process involving making cut-outs on a sheet of material, and rolling the material into a cylinder and bonding the resulting seam, such that the end product is a cylindrical component in which the cut-outs on the original sheet of material form the desired features on the cylindrical component.

45. The micro-turbine engine of claim 43, wherein one or more combustion chamber liners are made using sheet metal.

46. The micro-turbine engine of claim 43, wherein the cut-outs in one or more combustion chamber liners are fabricated using water jet cutting or laser cutting.

47. The micro-turbine engine of claim 25, wherein the primary plane within which a feature is curvilinear is not aligned with the primary plane of the component, and the feature is manufactured by first rotating the component such that the feature's primary plane aligns with the orientation of the manufacturing equipment.

48. A rotating component comprising a rotor disk that has features on one side of the rotor that are in contact with a fluid, and has a plurality of cooling blades on the opposite side of the rotor, and the cooling blade passages are a part of a separate flow path such that the cooling blades pump lower-temperature fluid through its flow path to cool the rotor, optionally wherein the component is a compressor rotor or a turbine rotor.
